(19) United States
(12) Patent Application Publication
(10) Pub. No.: US 2012/0323818 A1
(43) Pub. Date: Dec. 20, 2012

(54) FUNDING CAPITAL PROJECTS

(75) Inventor: Marshall Medoff, Brookline, MA (US)

(73) Assignee: XYLECO, INC., Woburn, MA (US)

(21) Appl. No.: 13/495,921

(22) Filed: Jun. 13, 2012

Related U.S. Application Data
(60) Provisional application No. 61/496,940, filed on Jun. 14, 2011.

(51) Int. Cl. G06Q 40/06

(52) U.S. Cl. 705/36 R

(57) ABSTRACT

Methods are disclosed which use an entity-based investment architecture to finance, in part or in whole, one or a series of projects of a parent company (or its Affiliates) to exploit a company's Protected Technologies, together with operational and administrative tools and machines to manage the investment architecture and related operations. These methods generally tend to reduce the likelihood of diluting the ownership interest of existing equity holders of the parent company or an Affiliate of the parent, as well as the likelihood of needing to separately raise investment funds for each individual project.

### RELATED APPLICATIONS

This application claims priority to U.S. Provisional Application Ser. No. 61/496,940, filed Jun. 14, 2011. The complete disclosure of this provisional application is hereby incorporated by reference herein.

### BACKGROUND

The efficient exploitation of intellectual property frequently requires significant capital investment. Obtaining the required capital often results in a complex financial and operational structure.

For example, when a company decides to undertake one or more projects or series of projects to exploit its intellectual property, such as the construction of a series of new manufacturing plants to produce products protected by its intellectual property rights or utilizing methods protected by its intellectual property rights, the company needs to obtain or provide funds for the payment of the costs related to such projects (e.g., the acquisition of real estate; construction of facilities; acquisition of furniture, fixtures and equipment; licensing costs; technology fees and funding working capital needs). Further, the company needs to monitor the performance of such projects (e.g., production levels, expenses, revenues, etc.), perform administrative tasks related to such projects (e.g., accounting, tax reporting, etc.) and calculate payments to be made with respect to such projects (e.g., payments to vendors, investors, licensors, parties entitled to royalty payments and the company and its affiliates).

Conventionally, when a company wants to finance projects to exploit its intellectual property and needs or elects to raise external financing for such projects, the company either (1) uses company-level funds derived from the sale of debt, equity or hybrid securities of the company, (2) separately obtains project-specific financing for each project, e.g., by creating a “single purpose entity”, or “SPE”, for each project and selling debt, equity and/or hybrid securities of the SPE in separate offerings to investors, or (3) uses a combination of these and/or other sources.

If the company finances project costs using company-level funds derived from the sale of its debt, equity or hybrid securities, (i) the ownership interests of equity holders of the company are generally diluted to the extent of the ownership interest in the company acquired by investors that purchase offered equity or hybrid securities, and (ii) financial returns to the equity holders of the company may be subordinated to any preferential claims on the assets of the company to which the holders of any offered preferred equity, hybrid or debt securities are entitled. On the other hand, if the company finances project costs by separately obtaining project-specific financing for each project (e.g., by creating one or more “single purpose entities”, or “SPEs”, for each project and selling debt, equity and/or hybrid securities of the SPE(s) to investors), the company will generally need to engage in repetitive offerings, which strategy is likely to be relatively slow and result in higher dilution, investment costs, expenses and fees.

### SUMMARY

In general, the invention pertains to methods of using an entity-based investment architecture to finance, in part or in whole, one or a series of projects of a parent company (or its Affiliates) to exploit a company's Protected Technologies, together with operational and administrative tools and machines to manage the investment architecture and related operations. These methods generally tend to reduce the likelihood of diluting the ownership interest of existing equity holders of the parent company or an Affiliate of the parent, as well as the likelihood of needing to separately raise investment funds for each individual project.

In the following discussion, the term “Parent” refers collectively to a parent company and its Affiliates, and the phrase “Parent-related Entity” refers to an Affiliate of the parent company, an entity in which the parent company or its Affiliates have an interest, or an agent or contractor of such Persons, in each case either acting singly or together with one or more Affiliates or third parties. “Affiliate” means, with respect to any Person, any other Person which controls, is controlled by or is under common control with such Person and the term “control”, for purposes of the foregoing, shall mean the power to direct or cause the direction of management and policies of an Entity, whether through ownership of voting securities, by contract or otherwise.

In one aspect, the invention features a process for obtaining capital financing, which includes: (a) formation, by a company, of an investment entity, (b) causing the investment entity to offer securities to third-party investors, (c) formation, by the company or an Affiliate thereof, of a project entity, the purpose of which is to conduct specified business activities relating, directly or indirectly, to the business of the company or its Affiliate, (d) causing the investment entity to acquire from the project entity securities of the project entity, and (e) causing the investment entity, either directly or through an Affiliate, to use a computerized system to perform one or more actions selected from the group consisting of storing information or data, determining or calculating information or data, and communicating information or data pertaining to the investment entity, the project entity, and/or the investors.

In another aspect, the invention features a process for obtaining capital financing that includes any of or any combination of the following steps (in any order):

a Parent forming a Fund, which serves as an investment entity and which, in some implementations, is managed and/or controlled, directly or indirectly, by the Parent and/or by a Parent-related Entity,

causing the Fund to offer, sell and issue securities (e.g., debt, equity or hybrid securities of the Fund) to third-party investors,

the Parent forming an Entity which is to conduct specified business activities relating, directly or indirectly, to the exploitation of Protected Technologies of the Parent (a “Project Entity”), which in some implementations is managed and/or controlled by the Parent and/or by a Parent-related Entity,

causing the Project Entity, directly or indirectly, to offer, sell and issue to the Fund, and causing the Fund to acquire from the Project Entity, securities (e.g., debt, equity or hybrid securities) of the Project Entity,

causing the Parent, directly or indirectly, to permit the Project Entity the right to use such Protected Technologies, by example through entering into a license or other agreement with the Project Entity,

causing the Fund, either directly or indirectly, by example through an Affiliate, to use a computerized system, which may be used, for example: (i) to store essential and important information including, e.g., the identity of the investors in the Fund and their respective interests in the securities issued by the Fund and/or (ii) to prepare information relating to such investments for such investors, and/or, (iii) to communicate such information to such investors as might be agreed upon among the Fund and its investors,

causing the Fund, either directly or indirectly, by example through an Affiliate, to use the computerized system, which may be used, for example: (i) to store information including the nature and amount of the investments of the Fund, and/or (ii) to store and determine or calculate data relating to such investments, such as amounts paid or payable with respect to such investments,

causing the Project Entity, either directly or indirectly, by example through an Affiliate, to use the computerized system, which may be used, for example: (i) to store information including the nature and amount of the securities issued by the Project Entity, and/or (ii) to store and determine or calculate data relating to such securities, such as amounts paid or payable with respect to such securities, and/or (iii) to manage its inventory and operations.

causing the Parent, either directly or indirectly, as by example through an Affiliate, to use the computerized system, which may be used, for example: (i) to obtain and store information on the operations of the Project Entity, e.g., productivity, expenses and revenue, and/or (ii) to calculate, store and disseminate information regarding the operations of the Project Entity, e.g., profitability, expenses, tax liabilities and other accounting information and performance metrics, and/or (iii) to provide information with respect to future engineering and process enhancements and projected performance.

In other aspects of the invention one or more of the foregoing steps may be performed by one or more Other Stakeholders in the transaction(s) described, in each case, either acting alone or in concert with one or more Other Stakeholders or the Parent. By “Other Stakeholder,” we mean a Person other than the Parent, which may include financial stakeholders (e.g., venture capital firms, hedge funds, investment banks, lenders, angel investors, family offices and other types of investors or investment managers) and strategic stakeholders (e.g., customers, suppliers, competitors and other industry participants). “Other Stakeholders” may be, but need not be, an equity holder of, licensee of, or providing services to, the Parent, the Fund and/or the Project Entity.

For example, in some implementations:
the Fund or the Project Entity may be formed, managed and/or controlled by an Other Stakeholder,
the securities of the Fund or the Project Entity may be offered or sold by an Other Stakeholder, and/or
the computerized systems utilized in the method may be owned and/or operated by an Other Stakeholder.

Some implementations of aspects of the invention disclosed herein may include one or more of the following features.

The method may further include the Parent forming an Entity (“Fund Manager”) which is to manage and/or control the Fund, and which is managed or controlled by the Parent and/or Other Stakeholder, either acting singly or together with one or more Affiliates or third parties.

The method may further include incorporating investment parameter, investment policy or investment limitation provisions into one or more agreements and/or instruments among the Fund and its investors. Such provisions can, for example, limit the general authority of the Entity managing or controlling the Fund to cause and direct the Fund to make investments.

The method may further include incorporating capital call provisions into one or more agreements and/or instruments among the Fund and its investors, which capital call provisions would obligate investors in the Fund to make additional capital contributions in respect of securities of the Fund held by them or acquire additional securities, subject to the restrictions on such capital call provisions (if any) set forth in such agreements and/or instruments.

In some cases, the Parent may retain securities of the Fund or the Project Entity issued in connection with the formation thereof and/or acquire securities of the Fund or the Project Entity, for example, by co-investing along with the third party investors in the Fund and/or along with the Fund in the Project Entity.

In some implementations, the Parent, the Entity managing or controlling the Fund (if not the Parent), their respective Affiliates, each of their respective employees and equity owners, the employees of the Fund or other service providers may be compensated. Compensation may be, for example, in connection with the offering or sale of interests of the Fund or a Project Entity, the conduct of the business of the Fund or a Project Entity or the liquidation of the Fund or a Project Entity, as may be agreed to or as may be appropriate. Such compensation may be payable, by way of example, in cash, securities, products, or other tangible or intangible assets.

The method may further include incorporating redemption provisions into one or more agreements and/or instruments among the Fund and its investors, which provisions provide for the redemption of securities of the Fund held by an investor, subject to the restrictions on such redemption rights (if any) set forth in such agreements and/or instruments. In such cases, redemption may be, for example, in the discretion of the investor or in the discretion of the Fund or the Fund Manager.

The method may further include incorporating provisions into one or more of the agreements and/or instruments among the Fund and its investors providing that the Fund has an obligation to liquidate, for example, at the end of a fixed term or upon the occurrence of one or more specified events.

The method may also include incorporating provisions into one or more of the agreements and/or instruments between the Fund and its investors that restrict the right of an investor to transfer all or a portion of its interest in the Fund.

The method may also include incorporating provisions into one or more of the agreements and/or instruments between the Parent or its Affiliate(s) and Other Stakeholder(s), if any, which provisions perform steps in the method.

The method may also include incorporating provisions into one or more of the agreements and/or instruments between the Parent and the Project Entity setting forth the ways in which the Project Entity or its Affiliate(s) is permitted to use the Protected Technologies.

In some implementations, the Fund may invest in projects identified prior to the purchase of securities of the Fund by its investors. In such cases, there may be one or more of agreements between the Fund and the Parent, as will be discussed in detail in the Detailed Description.

The obligations of the Fund pursuant to the securities issued by the Fund may in some cases be Collateralized by specified assets (for example, by listing such specified assets or by specifying all assets subject to a list of exceptions) of the Fund and/or of the Project Entity. “Collateralized,” and words of similar import refer to actions that result in the applicable obligations being secured by a security interest in the collateralized assets, including through a lien on such assets, terms of the applicable securities or by other means.

In some implementations the Project Entity is intended to be bankruptcy remote and accordingly has at least one operating requirement that establishes separateness of such Entity from one or more separate business Entities.

In some implementations, returns payable by the Project Entity to its investors (e.g., the Fund) or managers and/or returns payable by the Fund to its investors or managers may be payable, by way of example, in cash, securities, products, or other assets.

The securities purchased by the Fund or its investors, or the agreements relating to such investments, may incorporate terms whereby the Fund participates in the profits of, or is otherwise entitled to returns based in whole or in part on the performance of, the Parent with or without an equity interest in the Parent.

In some implementations the Parent offers to form or forms a series of Funds, and/or a series of Project Entities.

In some implementations the securities of the Fund may be publicly registered and/or listed for trading on one or more domestic or foreign stock exchanges or markets.

In some implementations the Fund is intended to offer philanthropic benefits. For example, the Fund may offer above market rates of return to charitable or philanthropic investors, all or a portion of the cash or other assets available for distribution by the Fund may be used for charitable or philanthropic purposes (e.g., donated for charitable or philanthropic purposes), or all or a portion of the product output of the Project Entities in which the Fund has an interest may be used for charitable or philanthropic purposes.

The offering by the Fund of interests in the Fund may be made, for example, in an offering that is not a public offering, or in an offering that is a public offering.

As used herein, the following terms shall have the meanings given:

“Entity” means any partnership, corporation, limited liability company, business trust or other entity.

“Person” means any individual or Entity, and the heirs, executors, administrators, legal representatives, successors and assigns of such individual or Entity where the context so permits.

“Protected Technologies” means, with respect to any Person, any invention, modification, discovery, design, development, improvement, enhancement, process, formula, data, technique, computer program, framework, methodology, analytical approach, work of authorship, know-how, trade secret or other intellectual property right whatsoever or any interest therein (whether or not patentable or registrable under copyright or similar statutes or subject to analogous protection) owned or licensed by such Person or its Affiliates.

References to securities “of” an Entity refer to securities issued by such Entity unless otherwise indicated.

### DETAILED DESCRIPTION

Although various embodiments are disclosed herein in the context of the construction and operation of manufacturing plants, the methods disclosed herein can be implemented in a broad range of circumstances where a Parent or Other Stakeholder(s) needs or elects to raise funds for the purpose of financing a plurality of projects to exploit the Protected Technologies of the Parent. For example, the methods described herein are useful in industries such as the paper industry, food industry, chemical industry, energy industry and large scale manufacturing industry, in each case in connection with the financing of projects such as manufacturing plants, storage and distribution centers and other corporate infrastructure projects relating to the production of products embodying the Protected Technologies.

An example of one implementation is now provided. A Parent (Parent Company or its Affiliate,) causes an Entity (“Fund”) to be formed that is managed or controlled by the Parent. The Fund can be formed and/or controlled indirectly, by example, by an Affiliate of the Parent Company. The Fund will function as an investment entity (for one or more investors) for funding projects, by example, of the Parent. Securities (e.g., debt, equity or hybrid securities) of the Fund are offered, in an offering, sold and issued to third-party investors. Such offering can, in certain implementations, constitute a public offering or an offering other than a public offering, for example, a private offering to a limited number of accredited (as such term is defined under applicable securities laws) third-party investors (e.g., high net worth individuals, corporate and institutional investors). Further, in certain embodiments of the invention, the Entity (or its Affiliates) that forms, manages or controls the Fund will retain securities of the Fund issued in connection with the formation thereof or otherwise acquire securities of the Fund, for example, by co-investing (along with the third party investors) in the Fund.

In addition, the Parent (Parent Company or its Affiliate) causes a Project Entity to be formed to hold the assets and operations of a project that is managed and/or controlled by the Parent. The Project Entity then offers and sells securities (e.g., debt, equity or hybrid securities of the Project Entity) to the Fund. In certain embodiments of the invention, the Parent Company or its Affiliates will retain securities of the Project Entity issued in connection with the formation thereof or otherwise acquire securities of the Project Entity, for example, by co-investing (along with the Fund) in the Project Entity.

In addition, the Parent enters into a license or other agreement with the Project Entity, conferring to the Project Entity a right to use such Protected Technologies.

In certain embodiments, a single Fund, by example, can invest in a plurality of Project Entities thereby providing funding for a plurality of projects of the Parent. In certain embodiments of the invention, the Parent will cause the formation of multiple Funds, each of which would offer, sell and issue its Securities (e.g., debt, equity or hybrid securities) to third-party investors as discussed above.

In other embodiments one or more of the foregoing steps are performed by one or more Other Stakeholders in the transaction(s) described, in each case, either acting alone or in concert with one or more Other Stakeholders, the Parent or its Affiliates. For example, in some implementations:
the Fund, the Project Entity or the Fund Manager is formed, managed and/or controlled by an Other Stakeholder,
the securities of the Fund or the Project Entity is offered or sold by an Other Stakeholder, and/or
the computerized systems utilized in the method is owned and/or operated by an Other Stakeholder.

Further, in certain embodiments, the agreements and/or instruments among a Fund and its investors can, for example, contain well-known provisions common to various types of investment entities, such as venture funds, hedge funds, real estate funds or other types of investment funds. For example, the agreements and/or instruments may in some cases provide for one or more of the following:
The agreements and/or instruments contain so-called investment parameters, policies or limitations, which limit the general authority of the Entity managing or controlling the Fund to cause and direct the Fund to make investments. For example, parameters may limit the authority of the Entity to cause the Fund to invest at more than a specified level (e.g., dollar amount or percentage of its total capital or capital commitments) in any particular project, to invest at more than a specified level in projects located in specified geographic regions, to invest at more than a specified level in a project involved in certain types of activities (e.g., plants producing a particular type of project), to acquire certain types of securities, or to make investments with or without the approval of one or more of the third party investors (or representatives thereof) with or without limit.
The agreements and/or instruments provide that investors have so-called capital commitments, requiring such investors either to pay additional amounts to the Fund in respect of securities purchased by them upon demand of the Fund, or acquire additional securities from the Fund, in each case subject to any limitations on such capital commitments agreed upon by the Fund and its investors. For example, such capital commitments may only be permitted within a fixed period of time (e.g., within a particular number of years of the closing of the Fund), may give investors a certain period of time in which to make such additional investments and/or may excuse investors, under certain circumstances, from making additional investments.
The agreements and/or instruments include redemption provisions providing for the redemption of securities of the Fund held by an investor, which provisions, for example, may provide for mandatory redemption (e.g., upon the occurrence of certain events), redemption in the discretion of such investor (i.e., put provisions), or redemption in the discretion of the Fund (i.e., call provisions), subject to the restrictions on such redemption provisions or rights (if any) set forth in such agreements and/or instruments.
The agreements and/or instruments provide that the Fund has an obligation to liquidate, for example, at the end of a fixed term (e.g., 7 to 15 years), subject to any extension options, or upon the occurrence of one or more specified events, or at any time.
The agreements and/or instruments provide for restrictions on the transfer by investors of an interest in the Fund.

In some implementations, the Fund invests in projects identified prior to the purchase of securities of the Fund by its investors. In such cases, there can be, for example, one or more of the following types of agreements between the Fund and the Parent, one or more of its Affiliates and/or one or more Project Entities:
agreement(s) providing that one or more Project Entities will issue securities of the applicable Project Entity to the Fund, which agreement(s) may be directly with such Project Entities and/or with the Parent or one or more of its Affiliates that control, directly or indirectly, such Project Entities (whereby the Parent or such Affiliate(s), as applicable, agree to cause the Project Entity to issue securities of the Project Entity to the Fund). Such agreements can, for example, provide that the proceeds derived by the Project Entities from the sale of such securities are used to fund the costs relating to the applicable project and/or reimburse or repay the Parent, one or more of its Affiliates or other Persons for amounts previously invested or otherwise used to fund such costs, for example, by repaying indebtedness owed to such Persons and/or redeeming securities of the Project Entity owned by such Persons.
agreement(s) providing that one or more holders of securities issued by one or more Project Entities will resell all or a portion of such securities to the Fund, which agreement(s) can be directly with such holder(s) or with one or more Affiliates of such holder(s) that control, directly or indirectly, such holder(s) (whereby such Affiliate(s) agree to cause such holder(s) to resell such securities to the Fund).
agreement(s) requiring Entities that own or have the right to acquire the assets related to one or more projects to sell or otherwise transfer such assets to another Entity where, by example, the Fund owns some or all of the securities of the transferee Entity or has the right to acquire such securities, which agreement(s) can be directly with one or more of the transferring Entities or with one or more Affiliates of such transferring Entities that control, directly or indirectly, such transferring Entities (whereby such Affiliate(s) agree to cause such transferring Entities to sell or otherwise transfer such assets).
in circumstances where the applicable project is identified but not fully constructed and/or the costs relating to such project are not fully funded, the agreement(s) can specify the rights and/or obligations of the Fund to invest in, and/or the rights and/or obligations of the Parent or one or more of its Affiliates to permit the Fund to invest in, such projects. For example, in some cases such agreements provide (i) that such project will be conducted by a particular Project Entity and that (x) the Fund has the right to purchase securities (e.g., debt, equity or hybrid securities) of such Project Entity or (y) that, upon the occurrence of certain events, the Fund has the right to require the holders of securities issued by such Project Entity to resell all or a portion of such securities to the Fund, or (ii) that Entities that own or have the right to acquire the assets related to one or more projects are required to sell or otherwise transfer such assets to an Entity where, by example, the Fund owns some or all of the securities of the transferee Entity or has the right to acquire such securities.
agreements containing a combination of the above-describe provisions.

In the alternative or in addition, the Fund will invest in projects that are not identified prior to the purchase of securities of the Fund by its investors. In such case, there can be one or more agreements between the Fund and the Parent or one or more of its Affiliates regarding the rights and/or obligations of the Fund to invest in, or the rights and/or obligations of such other Persons to permit the Fund to invest in, future projects. Such agreements can, for example, contain provisions similar in substance to those described above with respect to projects that are identified prior to the purchase of securities of the Fund by its investors and can be subject to one or more of the provisions contained in agreements and/or instruments among the Fund and its investors, including, for example, the investment parameter, investment policy or investment limitation provisions and capital call provisions described herein.

In some embodiments the Fund architecture described herein contains other customary attributes of investment entities. For example, the Parent Company, the Entity managing or controlling the Fund (if not the Parent Company), their respective Affiliates, each of their respective employees and equity owners, the employees of the Fund or other service providers can be compensated for services rendered to the Fund or a Project Entity. For example, the Fund or a Project Entity can pay fees or other compensation in respect of organization and offering activities, the conduct of the business of the Fund or a Project Entity (including management fees based on the amount of capital commitments, amounts invested and performance based fees, including pursuant to so-called carried interests) or the liquidation of a Fund or a Project Entity. Such compensation may be payable, by way of example, in cash, securities or products.

In certain embodiments of the invention, the Entity (“Fund Manager”) that controls or manages the Fund can be an Affiliate of the Parent Company, formed for the purpose of controlling or managing one or more Funds.

In some cases the investments by the Fund consist of equity investments where, for example, the Fund participates in the profits of the Project Entities in which it invests, debt investments which, for example, require a fixed or floating return based on the amount and time invested (e.g., simple or compound interest) or hybrid investments consisting of investment either in both debt and equity securities or in securities having characteristics of both types of investment. Alternatively, or in addition, the Fund or its investors may be entitled to returns based in whole or in part on the profits or other performance metrics of the Parent Company or one or more of its Affiliates. In some cases, distributions are made to investors, e.g., using electronic means such as electronic fund transfers. In some implementations, returns payable by the Project Entity to its investors (e.g., the Fund) or managers, and/or returns payable by the Fund to its investors or managers, may be payable, for example, in cash, securities or products.

Investors can monetize their interest in the Fund by, for example, reselling fund interests to third parties, pursuant to applicable exemptions for the resale of the applicable securities. Alternatively, investors can cause the Fund to redeem interests in accordance with redemption provisions of the agreements or instruments relating to the Fund (if such provisions are included), or hold the Fund interests until the liquidation of the Fund, for example, at the end of its term, in cases in which the Fund has a fixed term.

In some cases, the methods described herein include Collateralizing investments made in or by the Fund, for example, with specified assets of the Project Entities, e.g., tangible assets such as real property and equipment. The assets can be specified, for example, by listing such assets, or by specifying all assets subject to a list of exceptions. For example, the Fund can be structured so that technology of the Parent Company and its Affiliates is not Collateralized to secure investments in the Fund.

In some cases it is desirable for the Project Entities to be bankruptcy remote. This can be accomplished, for example, by the Project Entities establishing “separateness” from the Parent and other Persons based on various customary standards. These standards can, for example, be incorporated into the Project Entity's formation documents, which control its operation. For example, the formation documents can specify that the Project Entity will restrict its activities to only those necessary or incidental to the management and operation of its facilities, and not engage in other businesses or activities, and will hold itself out to the public as a legal entity separate and apart from its equity holders or any other Person, having its own assets, liabilities and operations—not constituting a branch or division of any of its equity holders, Affiliates or any other Person, and not being liable for the debts of any such Person. Other provisions may be dictated by custom in the financial field and applicable law.

Many of the essential steps of the method are performed utilizing computer systems and computer software or programs.

It is expected that such systems, software and programs will comprise a mix of “off-the-shelf” and customized components that are integrated across the operations of the Parent, the Fund, the Project Entities and their respective Affiliates.

Generally, such systems, software and programs will be used to collect, determine, store and disseminate information and data pertaining to the operation and/or management of the Parent, the Fund, the Project Entities and their respective Affiliates with respect to the described methods. In some implementations, the information and/or data is stored on a machine readable medium as part of a computer program product, which can be loaded into a computer system or other device or machine via a removable storage drive, hard drive, or communications interface. In some cases, the information and/or data or a portion thereof is stored on one or more servers, which may be in the possession of one or more of the parties and/or may be remote, e.g., in the case of a hosted or “cloud” system.

The computer-derived information can be electronically stored, and in some cases electronically communicated to investors and/or to other parties. Electronic communication can be, for example, by email, text messaging, and/or via a website, e.g., a website hosted by the Fund or its Affiliates. Such electronic communication can be in addition to or, in some cases, instead of non-electronic communications such as postal mail and courier. Generally, the nature of the information communicated, the manner in which it is communicated, and to whom particular information is communicated, is determined based on what is required for the Fund's operation, and is as permitted and agreed upon by Fund participants.

For example, computer programs are used by the Fund to:
store information consisting of the nature and amount of the investments of the Fund, and to store and determine or calculate data relating to such investments, such as amounts paid or payable with respect to such investments,
collect and store accounting data, and generate accounting statements, in each case in accordance with applicable standards in respect of the operations of the Fund, and
to store information consisting of the nature and amount of the securities issued by the Fund, and to store and determine or calculate data relating to such securities, such as amounts paid or payable with respect to such securities.

For example, computer programs are used by the Project Entity to:
collect and store accounting data, and generate accounting statements, in each case in accordance with applicable standards in respect of the operations of the Project Entity,
track and manage its inventory of raw materials, work in progress and finished products, and
to store information consisting of the nature and amount of the securities issued by the Project Entity, and to store and determine or calculate data relating to such securities, such as amounts paid or payable with respect to such securities.

For example, computer programs are used by the Parent Company to:
store information consisting of the nature and amount of the securities issued by the Project Entity, and to store and determine or calculate data relating to such securities such as amounts paid or payable with respect to such securities,
obtain from the Project Entity or an Affiliate, agent or contractor of the Project Entity, and store, information consisting of the amount of product manufactured during a given period, the costs relating to such products, the revenue relating to such products, and such other operational data as is customarily obtained and stored in a manufacturing operation,
calculate, store and disseminate to the Project Entity and/or the Fund, in respect of such given period, performance information relating to the operations of the Project Entity consisting of total profit, profit margin, total expenses, and such other performance information as is customarily calculated in a manufacturing operation,
calculate and store, in respect of the operations of the Project Entity during such given period, amounts payable to the Fund, parties entitled to royalty payments, the Parent and its Affiliates, and other parties,
calculate taxes due by the Project Entity, the Fund, the Parent and their respective Affiliates, in respect of the operations of the Project Entity,
engineer improvements to its Protected Technologies or operations of the Project Entity to improve the performance of the operations of the Project Entity during future periods, and
derive projections with respect to the performance of the operations of the Project Entity during future periods.

### EXAMPLES

Following are several prophetic examples of implementations of the invention described herein.

### Example 1

A company, that might be called Bluerock Industries, Inc., a Delaware corporation (“Bluerock”), owns all right, title and interest in a United States patent (the “Bluerock Patent”) granting it the right, among other things, to exclude others from making, using and selling a machine of its own invention (the “Bluerock Widget”).

Bluerock has determined that it will cost $100 million to build a factory (the “Bluerock Factory”) to manufacture the Bluerock Widget and fund the initial operations of the Bluerock Factory. Such funds will be used to acquire the real estate on which the Bluerock Factory will be built; design and construct the Bluerock Factory; acquire the furniture, fixtures and equipment to be used in the Bluerock Factory; and fund the other working capital needs of Bluerock Manufacturing prior to its generating sufficient cash flow to fund its operations. The determination as to how much funding is required, as well as the pro form a financial performance and returns that will be generated by the operation of the Bluerock Factory are calculated by using a computer system together with inputs provided by Bluerock and its employees, agents and advisors.

In preparation of raising the required funds:
Bluerock forms a Delaware limited liability company to act as a fund (“Bluerock Fund”) the purpose of which is to be an investment entity which aggregates investments of third party investors, which investments are to be used to buy membership interests in Bluerock Manufacturing (defined below). Formation of Bluerock Fund includes drafting a Certificate of Organization for Bluerock Fund, filing the same with the Delaware Secretary of State, drafting an operating agreement for Bluerock Fund, and execution of the same by Bluerock as the sole member and manager of Bluerock Fund.
Bluerock forms, as a Project Entity, a Delaware limited liability company (“Bluerock Manufacturing”) the sole purposes of which are to license the right to manufacture the Bluerock Widget from Bluerock, to build the Bluerock Factory, to manufacture and sell Bluerock Widgets and to conduct such other business activities as are incidental thereto. Formation of Bluerock Manufacturing includes drafting a Certificate of Organization for Bluerock Manufacturing, filing the same with the Delaware Secretary of State, drafting an operating agreement for Bluerock Manufacturing, and execution of the same by Bluerock as the sole member and manager of Bluerock Manufacturing.
Bluerock enters into a license agreement (the “Bluerock License”) with Bluerock Manufacturing granting Bluerock Manufacturing the exclusive right to manufacture the Bluerock Widget and to use certain of Bluerock's other Protected Technologies related thereto. The Bluerock License also provides that a royalty equal to $100,000 is payable by Bluerock Manufacturing to Bluerock for each Bluerock Widget sold by Bluerock Manufacturing.

Bluerock then causes Bluerock Fund to prepare a private placement memorandum (the “Bluerock PPM”), using a computer system, regarding the offering, by Bluerock Fund, of its membership interests to third party investors residing in the United States who are “accredited investors” under applicable United States securities laws. The Bluerock PPM contains, among other things, descriptions of the terms of the operating agreement of Bluerock Fund, the terms of the operating agreement of Bluerock Manufacturing, the business to be conducted by Bluerock Manufacturing (including the design, building and operation of the Bluerock Factory as well as the pro form a financial performance and returns thereof as discussed above) and the terms of the Bluerock License.

The membership interests offered by Bluerock Fund are equity interests in the fund which entitle an investor, among other things, to receive a proportion of the cash or other assets distributed by the fund equal to the proportion that such investor's capital contribution to the fund bears to the capital contributions of all investors in the fund. For example, if an investor invests 25% of the total capital invested in the fund, it is entitled to receive 25% of the cash or other assets distributed by the fund.

The Bluerock PPM is then transmitted by electronic mail to seven prospective investors; three of which acquire membership interests in Bluerock Fund as follows:

| Investor | Amount Invested | Percentage Interest |
|---|---|---|
| Investor A | $50 million | 50% |
| Investor B | $30 million | 30% |
| Investor C | $20 million | 20% |
| Total: | $100 million | 100% |

Upon the sale of membership interests to the three investors, Bluerock withdraws as a member of Bluerock Fund and ceases to have any membership interest therein. It continues, however, to control Bluerock Fund, as manager, in accordance with the terms of the operating agreement of Bluerock Fund.

Bluerock then causes Bluerock Manufacturing to offer membership interests in Bluerock Manufacturing to Bluerock Fund in a private offering and causes Bluerock Funds to use the net proceeds of its offering ($100 million) to buy 90% of the membership interests in Bluerock Manufacturing. Bluerock retains a 10% membership interest in Bluerock Manufacturing. Accordingly, Bluerock Manufacturing is owned as follows:

| Holder | Amount Invested | Percentage Interest |
|---|---|---|
| Bluerock | $0 | 10% |
| Bluerock Fund | $100 million | 90% |
| Total: | $100 million | 100% |

The membership interests offered by Bluerock Manufacturing are equity interests in the entity which entitle a holder of its membership interests, among other things, to receive a proportion of the cash or other assets distributed by the entity equal to the proportion that such holder's percentage interest bears to the percentage interest of all holders of membership interests in the entity.

Bluerock then causes a computer system to be used to record and store (a) the amounts invested in Bluerock Fund by, the percentage interests in Bluerock Fund of, and the addresses and other identifying information of Investor A, Investor B and Investor C; and (b) the amounts invested in Bluerock Manufacturing by, the percentage interests in Bluerock Manufacturing of, and the addresses and other identifying information of Bluerock and Bluerock Fund.

Bluerock Manufacturing then builds and outfits the Bluerock Factory, purchases the component parts and other raw materials and supplies required to manufacture Bluerock Widgets and commences operations, a process which takes 12 months.

Concurrently, Bluerock Manufacturing implements an enterprise resource planning, or ERP, system customized to:
Record, store and analyze Bluerock Manufacturing's revenues;
Record, store and analyze Bluerock Manufacturing's capital, operating and other costs, including the costs relating to the building and outfitting of the Bluerock Factory, the manufacturing of Bluerock Widgets (including the royalty payments payable under the Bluerock License) and its other business activities;
Record, store and analyze Bluerock Manufacturing's raw materials and finished goods inventory and other items customarily tracked in operations of such nature; and
Transmit pertinent financial and other information to computer systems implemented by (a) Bluerock to monitor the performance of Bluerock Manufacturing and its interest therein as well as the performance of the Bluerock Factory, and (b) Bluerock Fund to track the performance of its investment in Bluerock Manufacturing.

At the end of such 12 month period, Bluerock Manufacturing has spent $75 million of its $100 million, of which $50 million was spent on capital assets which will be depreciated over the course of an average of 10 years (i.e., $5 million per year) and $25 million in operating expenses. Accordingly, Bluerock Manufacturing's ERP system determines and transmits to Bluerock and Bluerock Fund that, after the first year of operations, it has:
generated $0 in revenues,
generated $30 million in losses ($25 million in operating expenses, plus $5 million in depreciation on capital assets),
ended the period with $70 million in assets ($25 million in cash, plus $45 million in capital assets net of depreciation), and
such other information as is customary given the nature of Bluerock Manufacturing's operations.

In addition, Bluerock Manufacturing's ERP system is used to perform customary financial accounting operations and tax reporting with respect to such results. For example, such system would determine, assuming that Bluerock Manufacturing is a “flow-through” entity for tax purposes, that $27 million of the losses incurred (90%) are allocable to Bluerock Fund and $3 million of the losses incurred (10%) are allocable to Bluerock. In turn:
The computer system of Bluerock takes the information transmitted by Bluerock Manufacturing's ERP system and determines such information as is relevant to its operations. For example, the ERP system may analyze such performance to facilitate monitoring by Bluerock personnel and create projections for the operations of Bluerock Manufacturing in year 2.
The computer system of Bluerock Fund takes the information transmitted by Bluerock Manufacturing's ERP system and determines such information as is relevant to its operations. For example, such system would determine, assuming that Bluerock Fund is a “flow-through” entity for tax purposes, that the $27 million of the losses allocable to Bluerock Fund are further allocated to the investors in Bluerock Fund as follows:

| Investor | Percentage Interest | Allocable Loss |
|---|---|---|
| Investor A | 50% | $13,500,000 |
| Investor B | 30% | $8,100,000 |
| Investor C | 20% | $5,400,000 |
| Total: | 100% | $27,000,000 |

In year 2, Bluerock Manufacturing commences manufacturing operations. Over the course of such year, Bluerock Manufacturing manufactures 100 Bluerock Widgets.

The retail price of a Bluerock Widget is $1 million, each of which costs $500,000 to manufacture (excluding the royalty payable under the Bluerock License and any allocation of the depreciation of capital assets attributable to the period in which such production takes place). During such year, Bluerock Manufacturing sells 90 of the Bluerock Widgets produced by it, leaving 10 Bluerock Widgets in inventory. Accordingly, Bluerock Manufacturing's ERP system determines and transmits to Bluerock and Bluerock Fund that, after the second year of operations, it has:
generated $90 million in revenues,
incurred $59 million in expenses ($45 million in operating costs relating to the 90 Bluerock Widgets sold during the period, plus $9 million in royalties payable to Bluerock, plus $5 million in depreciation on capital assets),
generated $31 million in profits,
ended the period with a finished goods inventory of $5 million ($500,000 in operating expenses per Bluerock Widget manufactured multiplied by the 10 Bluerock Widgets manufactured but not sold during the period),
ended the period with $106 million in assets ($61 million in cash, plus $40 million in capital assets net of depreciation, plus $5 million of finished goods inventory), and
such other information as is customary given the nature of Bluerock Manufacturing's operations.

In addition, Bluerock Manufacturing's ERP system is used to perform customary financial accounting operations and tax reporting with respect to such results. For example, such system would determine, assuming that Bluerock Manufacturing is a “flow-through” entity for tax purposes, that $27.9 million of the profit generated (90%) is allocable to Bluerock Fund and $3.1 million of the profit generated (10%) is allocable to Bluerock. In turn:
The computer system of Bluerock takes the information transmitted by Bluerock Manufacturing's ERP system and determines such information as is relevant to its operations, for example, analyzing such performance to facilitate monitoring by Bluerock personnel and creating projections for the operations of Bluerock Manufacturing in year 3.
The computer system of Bluerock Fund takes the information transmitted by Bluerock Manufacturing's ERP system and determines such information as is relevant to its operations. For example, such system would determine, assuming that Bluerock Fund is a “flow-through” entity for tax purposes, that the $27.9 million of the profits allocable to Bluerock Fund are further allocated to the investors in Bluerock Fund as follows:

| Investor | Percentage Interest | Allocable Loss |
|---|---|---|
| Investor A | 50% | $13,950,000 |
| Investor B | 30% | $8,370,000 |
| Investor C | 20% | $5,580,000 |
| Total: | 100% | $27,900,000 |

At the end of such year, Bluerock Manufacturing elects to distribute $20 million of its cash. Accordingly, Bluerock Manufacturing's ERP system would determine that $18 million (90%) of such cash is distributable to Bluerock Fund and $2 million (10%) of such cash is distributable to Bluerock. In turn, Bluerock Fund's computer system would determine that the $18 million received by it (assuming that all of such funds were distributed), are distributable to its investors as follows:

| Investor | Percentage Interest | Funds Receivable |
|---|---|---|
| Investor A | 50% | $9,000,000 |
| Investor B | 30% | $5,400,000 |
| Investor C | 20% | $3,600,000 |
| Total: | 100% | $18,000,000 |

### Example 2

A company, that might be called Redrock Industries, Inc., a Delaware corporation (“Redrock”), owns all right, title and interest in a United States patent (the “Redrock Patent”) granting it the right, among other things, to exclude others from making, using and selling a machine of its own invention (the “Redrock Widget”).

Redrock has determined that it will cost $100 million to build a factory (“Redrock Factory”) to manufacture the Redrock Widget, and to fund the initial operations of the Redrock Factory. Such funds will be used to acquire the real estate on which the Redrock Factory will be built; design and construct the Redrock Factory; acquire the furniture, fixtures and equipment to be used in the Redrock Factory; and fund the other working capital needs of Redrock Manufacturing prior to its generating sufficient cash flow to fund its operations. The determination as to how much funding is required, as well as the pro form a financial performance and returns that will be generated by the operation of the Redrock Factory, are calculated using a computer system with inputs provided by Redrock and its employees, agents and advisors.

Redrock desires to have funding committed to build up to ten Redrock Factories.

In preparation of raising the required funds:
Redrock forms a joint venture with a third party investment banking and fund management company called Quarry Capital. The agreements relating to the joint venture provide, among other things, that: (a) Quarry Capital and Redrock will form a Delaware limited liability company to act as a fund manager (“Redrock Fund Manager”) the purpose of which is to form and manage Redrock Fund (defined below), (b) Quarry Capital and Redrock will manage Redrock Fund Manager, and (c) Quarry Capital and Redrock will each be entitled to receive 50% of the cash or other assets distributed by Redrock Fund Manager.
Redrock and Quarry Capital form Redrock Fund Manager. Formation of Redrock Fund Manager includes drafting a Certificate of Organization for Redrock Fund Manager, filing the same with the Delaware Secretary of State, drafting an operating agreement for Redrock Fund Manager, and execution of the same by Quarry Capital and Redrock, each as a 50% member and manager of Redrock Fund Manager.
Redrock Fund Manager forms a Delaware limited liability company to act as a fund (“Redrock Fund”) the purpose of which is to be an investment entity which aggregates investments of third party investors, which investments are to be used to buy membership interests in Redrock Manufacturing Entities (defined below). Formation of Redrock Fund includes drafting a Certificate of Organization for Redrock Fund, filing the same with the Delaware Secretary of State, drafting an operating agreement for Redrock Fund, and execution of the same by Redrock Fund Manager as the sole member and manager of Redrock Fund.
Redrock forms a Delaware limited liability company (“Redrock Manufacturing 1”) the sole purposes of which are to license the right to manufacture the Redrock Widget from Redrock, to build a Redrock Factory, to manufacture and sell Redrock Widgets and to conduct such other business activities as are incidental thereto. Formation of Redrock Manufacturing 1 includes drafting a Certificate of Organization for Redrock Manufacturing 1, filing the same with the Delaware Secretary of State, drafting an operating agreement for Redrock Manufacturing 1, and execution of the same by Redrock as the sole member and manager of Redrock Manufacturing 1. Additional such entities (each a “Redrock Manufacturing Entity”) may be formed, each to conduct the operations of a single Redrock Factory.
Redrock enters into a license agreement with Redrock Manufacturing 1 granting Redrock Manufacturing 1 the non-exclusive right to manufacture the Redrock Widget and to use certain of Redrock's other Protected Technologies related thereto. The Redrock License also provides that a royalty equal to $100,000 is payable by Redrock Manufacturing to Redrock for each Redrock Widget sold by Redrock Manufacturing. Additional such licenses (each, including the license between Redrock and Redrock Manufacturing 1 described above, a “Redrock License”) would be entered into between Redrock and future Redrock Management Entities.

Redrock and Quarry Capital then cause Redrock Fund to use a computer system to prepare a private placement memorandum (the “Redrock PPM”) regarding the offering, by Redrock Fund, of its membership interests to third party investors residing in the United States who are “accredited investors” under applicable United States securities laws. The Redrock PPM contains, among other things, descriptions of the terms of the operating agreement of Redrock Fund, the terms of the operating agreement of Redrock Manufacturing 1 (and any additional Redrock Manufacturing Entities to be formed in the future), the business to be conducted by Redrock Manufacturing 1 (and any additional Redrock Manufacturing Entities to be formed in the future), including the design, building and operation of the Redrock Factory as well as the pro form a financial performance and returns thereof as discussed above, and the terms of the Redrock License.

The offering by Redrock Fund is for membership interests that, in the aggregate, would require investors to commit to invest up to $1 billion (to fund the construction of 10 Redrock Factories and related operations) and initially invest 10% of their aggregate capital commitment (to fund the construction of the Redrock Factory to be constructed by Redrock Manufacturing 1 and related operations).

The membership interests offered by Redrock Fund are equity interests in the fund which entitle an investor, among other things, to receive a proportion of the cash or other assets distributed by the fund equal to the proportion that such investor's capital contribution to the fund bears to the capital contributions of all investors in the fund; provided that Redrock Fund Management is entitled to a management fee equal to 20% of all cash or other property received by Redrock Fund. For example, Redrock Fund receives $100, Redrock Fund Manager would receive $20 as a management fee, and then, if an investor invested 25% of the total capital invested in the fund, that investor would be entitled to receive 25% of the cash or other assets distributed by the fund after payment of the management fee.

The Redrock PPM is then transmitted by electronic mail to seven prospective investors; three of which acquire membership interests in Redrock Fund as follows:

| | | | Percentage |
|---|---|---|---|
| Investor | Capital Commitment | Initial Investment | Interest |
| Investor A | $500 million | $50 million | 50% |
| Investor B | $300 million | $30 million | 30% |
| Investor C | $200 million | $20 million | 20% |
| Total: | $1 billion | $100 million | 100% |

Upon the sale of membership interests to the three investors, Redrock Fund Manager withdraws as a member of Redrock Fund and ceases to have any membership interest therein. It continues, however, to control Redrock Fund, as manager, in accordance with the terms of the operating agreement of Redrock Fund.

Redrock then causes Redrock Manufacturing 1 to offer membership interests in Redrock Manufacturing 1 to Redrock Fund in a private offering and causes Redrock Funds to use the net proceeds of its offering ($100 million) to buy 90% of the membership interests in Redrock Manufacturing. Redrock retains a 10% membership interest in Redrock Manufacturing. Accordingly, Redrock Manufacturing is owned as follows:

| HolderAmount | Invested | Percentage Interest |
|---|---|---|
| Redrock | $0 | 10% |
| Redrock Fund | $100 million | 90% |
| Total: | $100 million | 100% |

The membership interests offered by Redrock Manufacturing 1 are equity interests in the entity which entitle a holder of its membership interests, among other things, to receive a proportion of the cash or other assets distributed by the entity equal to the proportion that such holder's percentage interest bears to the percentage interest of all holders of membership interests in the entity.

Redrock then causes a computer system to be used to record and store (a) the amounts invested in Redrock Fund by, the percentage interests in Redrock Fund of, and the addresses and other identifying information of Investor A, Investor B and Investor C; and (b) the amounts invested in Redrock Manufacturing 1 by, the percentage interests in Redrock Manufacturing 1 of, and the addresses and other identifying information of, Redrock and Redrock Fund.

Redrock Manufacturing 1 then builds and outfits the Redrock Factory, purchases the component parts and other raw materials and supplies required to manufacture Redrock Widgets, and commences operations, a process which takes 12 months. Concurrently, Redrock Manufacturing 1 implements an enterprise resource planning, or ERP, system customized to:
Record, store and analyze Redrock Manufacturing 1's revenues;
Record, store and analyze Redrock Manufacturing 1's capital, operating and other costs, including the costs relating to the building and outfitting of the Redrock Factory, the manufacturing of Redrock Widgets (including the royalty payments payable under the Redrock License) and its other business activities;
Record, store and analyze Redrock Manufacturing 1's raw materials and finished goods inventory and other items customarily tracked in operations of such nature; and
Transmit pertinent financial and other information to computer systems implemented by (a) Redrock to monitor the performance of Redrock Manufacturing and its interest therein as well as the performance of the Redrock Factory, and (b) Redrock Fund to track the performance of its investment in Redrock Manufacturing.

At the end of such 12 month period, Redrock decides to begin construction of a second Redrock Factory. In preparation of such construction:
Redrock and Quarry Capital cause Redrock Fund Manager to cause Redrock Fund to require the investors to invest an additional $100 million in Redrock Fund. After such investments, Redrock Fund is owned as follows:

| | | | Percentage |
|---|---|---|---|
| Investor | Capital Commitment | Initial Investment | Interest |
| Investor A | $500 million | $100 million | 50% |
| Investor B | $300 million | $60 million | 30% |
| Investor C | $200 million | $40 million | 20% |
| Total: | $1 billion | $200 million | 100% |

Redrock forms a second Redrock Manufacturing Entity (“Redrock Manufacturing 2”).
Redrock enters into a Redrock License with Redrock Manufacturing 2.

Redrock Manufacturing 2 then builds and outfits the Redrock Factory, purchases the component parts and other raw materials and supplies required to manufacture Redrock Widgets, and commences operations, a process which takes 12 months. Concurrently, Redrock Manufacturing 1's ERP system is further customized to monitor the operations of Redrock Manufacturing 2.

The operations of the Redrock Manufacturing Entities, the performance of the Redrock Factories, and the accounting, tax and other analyses performed by the ERP system are substantially similar to those described in the previous example relating to the “Bluerock” entities.

At the end of three years, Redrock Manufacturing 1 elects to distribute $40 million of its cash and Redrock Manufacturing 2 elects to distribute $30 million of its cash. Accordingly, the ERP system would determine that (a) $36 million (90%) of the cash distributable by Redrock Manufacturing 1 is distributable to Redrock Fund and $4 million (10%) of such cash is distributable to Redrock, and (b) $27 million (90%) of the cash distributable by Redrock Manufacturing 2 is distributable to Redrock Fund and $3 million (10%) of such cash is distributable to Redrock. In turn, Redrock Fund's computer system would determine that, of the $63 million received by it, $12.6 million (20%) would be payable to Redrock Fund Management as a management fee, and the balance of $50.4 million (assuming that all of such funds were distributed) is distributable as follows:

| Investor | Percentage Interest | Funds Receivable |
|---|---|---|
| Investor A | 50% | $25,200,000 |
| Investor B | 30% | $15,120,000 |
| Investor C | 20% | $10,080,000 |
| Total: | 100% | $50,400,000 |

Further, Redrock Fund Manager's computer system would determine that the $12.6 million paid to Redrock Fund Manager from Redrock Fund as a management fee (assuming that all of such funds were distributed) is distributable as follows:

| Member | Percentage Interest | Funds Receivable |
|---|---|---|
| Redrock | 50% | $6,300,000 |
| Quarry Capital | 50% | $6,300,000 |
| Total: | 100% | $12,600,000 |

### Other Embodiments

A number of embodiments have been described. Nevertheless, it will be understood that various modifications may be made without departing from the spirit and scope of the disclosure. Accordingly, other embodiments are within the scope of the following claims.

What is claimed is:

1. A process by which a Parent obtains capital financing, the process comprising:
(a) formation by the Parent, or formation, on behalf of the Parent, for the benefit of the Parent, or in concert with the Parent, by an Other Stakeholder, of (i) an Investment Fund that issues securities to third party investors, and (ii) a Project Entity that issues securities to the Investment Fund, each of which is managed and/or controlled by the Parent and/or the Other Stakeholder; and
(b) using a computer to perform one or more of the following functions:
store information consisting of the identity of the investors in the Fund and their respective interests in the securities issued by the Fund and prepare information relating to such investments for such investors, and/or to communicate such information to such investors as agreed upon among the Fund and its investors,
store information consisting of the nature and amount of the investments of the Fund, and store and determine or calculate data relating to such investments such as amounts paid or payable with respect to such investments,
collect and store accounting data, and generate accounting statements, in each case in accordance with applicable standards in respect of the operations of the Fund,
store information consisting of the nature and amount of the securities issued by the Project Entity, and store and determine or calculate data relating to such securities such as amounts paid or payable with respect to such securities,
collect and store accounting data, and generate accounting statements, in each case in accordance with applicable standards in respect of the operations of the Project Entity,
obtain and store information consisting of the amount of product manufactured during a given period, the costs relating to such products, the revenue relating to such products, and such other operational data as is customarily obtained and stored in a manufacturing operation,
calculate, store and disseminate to the Project Entity and/or the Fund, in respect of such given period, performance information relating to the operations of the Project Entity consisting of total profit, profit margin, total expenses, and such other performance information as is customarily calculated in a manufacturing operation,
calculate and store, in respect of the operations of the Project Entity during such given period, amounts payable to the Fund, parties entitled to royalty payments, the Parent and its Affiliates, and other parties,
calculate taxes due by the Project Entity, the Fund, the Parent and their respective Affiliates, in respect of the operations of the Project Entity,
engineer improvements to technologies or operations of the Project Entity to improve the performance of the operations of the Project Entity during future periods,
derive projections with respect to the performance of the operations of the Project Entity during future periods, and/or
track and manage the Project Entity's inventory of raw materials, work in progress and finished products.

2. The process of claim 1 wherein proceeds of the issuance of securities to the investors are used by the Fund to acquire the securities issued by the Project Entity.

3. The process of claim 1 wherein there are a plurality of said third party investors, and the Fund serves to aggregate the investments made by the investors.

4. The process of claim 1 further comprising the Project Entity causing one or more manufacturing facilities to be built using the proceeds from the issuance of its securities to the Fund.

5. The process of claim 1 further comprising formation, by the Parent of a Fund Manager which manages the Fund and which is managed or controlled by the Parent.

6. The process of claim 1 wherein the Parent has Protected Technology and the process further comprises the Parent entering into a license or other agreement with the Project Entity conferring a right to use such Protected Technology to the Project Entity.

7. The process of claim 6 further comprising the Project Entity manufacturing one or more products embodying the Protected Technology.

8. The process of claim 7 further comprising the Project Entity paying royalties on sales of such products to Parent under the license or agreement.

9. The process of claim 1 further comprising incorporating investment parameter provisions into one or more agreements and/or instruments among the Fund and its investors, which investment parameter provisions would limit the general authority of the Entity managing or controlling the Fund to cause and direct the Fund to make investments.

10. The process of claim 1 further comprising incorporating capital call provisions into one or more agreements and/or instruments among the Fund and its investors.

11. The process of claim 1 wherein the Parent invests in the Fund and/or in the Project Entity.

12. The process of claim 1 wherein the Parent and/or employees or equity owners of the Parent is/are compensated in connection with the offering of interests in the Fund or the conduct of the business of the Fund.

13. The process of claim 1 further comprising incorporating redemption provisions into one or more agreements and/or instruments among the Fund and its investors, which provide for the redemption of interests in the Fund held by an investor.

14. The process of claim 1 further comprising incorporating liquidation provisions into one or more of the agreements and/or instruments among the Fund and its investors.

15. The process of claim 1 further comprising incorporating provisions into one or more of the agreements and/or instruments among the Fund and its investors that restrict the right of an investor to transfer all or a portion of its interest in the Fund.

16. The process of claim 1 wherein the obligations of the Fund pursuant to the securities issued by the Fund are Collateralized by specified assets of the Fund and/or the Project Entity.

17. The process of claim 1 wherein the obligations of the Project Entity pursuant to the securities issued by the Project Entity are Collateralized by specified assets (either by listing such specified assets or by specifying all assets subject to a list of exceptions) of the Project Entity.

18. The process of claim 16 wherein the assets comprise tangible assets.

19. The process of claim 16 wherein the Fund is structured so that technology of the Parent is not Collateralized to secure investments in the Fund.

20. The process of claim 1 wherein the Project Entity is intended to be bankruptcy remote and accordingly has at least one operating requirement that establishes separateness of the Project Entity from one or more separate business Entities.

21. The process of claim 1 wherein the securities purchased by the Fund incorporate terms whereby the Fund participates in the profits of the Parent or is otherwise entitled to returns based in whole or in part on the performance of the Parent.

22. The process of claim 1 wherein the Parent forms a series of Funds.

23. The process of claim 1 wherein the Parent forms a series of Project Entities.

24. The process of claim 1 wherein the offering by the Fund of interests in the Fund is made in an offering that is not a public offering.

25. The process of claim 1 wherein the offering by the Fund of interests in the Fund is made in an offering that is a public offering.

26. The process of claim 1 wherein the Fund offers benefits to charitable or philanthropic investors.

27. The process of claim 1 wherein all or a portion of cash available for distribution by the Fund is used for charitable or philanthropic purposes.

28. The process of claim 1 wherein all or a portion of the product output of the Project Entities in which the Fund has an interest may be used for charitable or philanthropic purposes.

29. The process of claim 1 wherein a server is used to store and transmit information and data pertaining to the Fund and/or the Project Entity.

30. The process of claim 1 wherein the Fund utilizes a website to enable online transactions by the third party investors.

31. The process of claim 1 further comprising the Project Entity utilizing an Enterprise Resource Planning (ERP) system.

32. The process of claim 31 wherein the ERP system is used to record, store and analyze data pertaining to revenues, capital, inventories, and operating and other costs.

33. The process of claim 1 wherein the computer is used to store information consisting of the identity of the investors in the Fund and their respective interests in the securities issued by the Fund and prepare information relating to such investments for such investors, and/or to communicate such information to such investors as agreed upon among the Fund and its investors.

34. The process of claim 1 wherein the computer is used to store information consisting of the nature and amount of the investments of the Fund, and store and determine or calculate data relating to such investments such as amounts paid or payable with respect to such investments.

35. The process of claim 1 wherein the computer is used to collect and store accounting data, and generate accounting statements, in each case in accordance with applicable standards in respect of the operations of the Fund.

36. The process of claim 1 wherein the computer is used to store information consisting of the nature and amount of the securities issued by the Project Entity, and store and determine or calculate data relating to such securities such as amounts paid or payable with respect to such securities.

37. The process of claim 1 wherein the computer is used to collect and store accounting data, and generate accounting statements, in each case in accordance with applicable standards in respect of the operations of the Project Entity.

38. The process of claim 1 wherein the computer is used to obtain and store information consisting of the amount of product manufactured during a given period, the costs relating to such products, the revenue relating to such products, and such other operational data as is customarily obtained and stored in a manufacturing operation.

39. The process of claim 1 wherein the computer is used to calculate, store and disseminate to the Project Entity and/or the Fund, for a given period, performance information relating to the operations of the Project Entity consisting of total profit, profit margin, total expenses, and such other performance information as is customarily calculated in a manufacturing operation.

40. The process of claim 1 wherein the computer is used to calculate and store, in respect of the operations of the Project Entity during such given period, amounts payable to the Fund, parties entitled to royalty payments, the Parent and its Affiliates, and other parties.

41. The process of claim 1 wherein the computer is used to calculate taxes due by the Project Entity, the Fund, the Parent and their respective Affiliates, in respect of the operations of the Project Entity,

42. The process of claim 1 wherein the computer is used to assist the Project Entity with engineering improvements to technologies or operations of the Project Entity to improve the performance of the operations of the Project Entity during future periods.

43. The process of claim 1 wherein the computer is used to derive projections with respect to the performance of the operations of the Project Entity during future periods, and/or to track and manage the Project Entity's inventory of raw materials, work in progress and finished products.

44. The process of claim 1 wherein the Project Entity will utilize Protected Technology of the Parent to manufacture a product.
